(19) United States
(12) Patent Application Publication
(10) Pub. No.: US 2007/0233785 A1
(43) Pub. Date: Oct. 4, 2007

(54) Communicating using collaboration spaces

(75) Inventors: Subil M. Abraham, Plano, TX (US); Tsz S. Cheng, Grand Prairie, TX (US); Daniel Hassell, Flower Mound, TX (US); Mathews Thomas, Flower Mound, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/394,001

(22) Filed: Mar. 30, 2006

(51) Int. Cl. G06F 15/16

(52) U.S. Cl. 709/204

(57) ABSTRACT

A collaboration interface including a collaboration space and a collaboration space list. The collaboration space can be associated with at least one key attribute. The collaboration space list can include an identifier for each communicator occupying the collaboration space. The communicators occupying the collaboration space can be automatically and dynamically determined. The interface can include a graphical user interface section for composing a message. Further, the interface can include a user selectable mechanism for conveying a composed message. The mechanism can convey the message to user selected ones of the communicators occupying the collaboration space.

### BACKGROUND

1. Field of the Invention

The present invention relates to the field of communications, and, more particularly, to communicating using collaboration spaces.

2. Description of the Related Art

Collaborating using instant messaging, email, chat rooms, and other communication modes are becoming increasing popular. Regardless of which communication mode is utilized, each communicator involved in a collaboration must utilize an interface established for that mode of communication. One of the communicators must initialize a communication using his or her interface, which requires specifying each collaborator with whom that party wishes to collaborate. Typically, the party specifies a desired communicator using a user identifier, such as an email account name or an instant messaging user identifier.

This mechanism works fairly well for many situations. It does not work well, however, when a collaboration is desired for a particular event. For instance, if a party wishes to send an email message to each attendee of a meeting, multiple manual steps are generally required. For example, a party must first determine who attended the meeting. The party must then locate email addresses associated with each attendee and explicitly designate these attendees by name as email recipients. If attendees are relatively consistent and a meeting reoccurring, often a distribution list will be developed that includes each meeting attendee so that future email messages can be sent by selecting the distribution list.

Conventional collaboration methods are not particularly helpful when a set of communicators constantly changes. The situation is worse when a party desires to collaborate in real time with a set of communicators who have common attributes, but whose individual identities are unknown to the party.

What is needed is a flexible collaboration technology where collaborations can be initiated by a common attribute other than communicator identities and where multiple different modes of communication can be initiated from a single interface.

### SUMMARY OF THE INVENTION

The present invention discloses the concept of a collaboration space containing multiple communicators. A collaboration space can be defined by one or more key attributes, such as communicator location, title, skill-set, organization, band-level, and the like. The key attributes can be either relatively static attributes or dynamically changing attributes. As changes occur, membership within the collaboration space can dynamically change.

An example of a relatively static collaboration space can include “all managers in a company.” Membership of the “all managers” collaboration space may be based upon data entries in a company's personnel system, in a contact management system, or similar system. The system that determines membership in a collaboration space can be an information system separate from a communication system used to exchange communications with collaborators. For example, a company's personnel system is not necessary integrated with an email system, which can send email messages to communicators in the collaboration space as described herein.

An example of a dynamic collaboration space can include all communicators currently located in Room ABC, which changes as communicators enter and leave Room ABC. In embodiments where a collaboration space is defined at least in part by location, any of a variety of location identifying technologies, such as the use of radio frequency identification (RFID) tags, can be used to determine communicator locations in real-time.

It should be appreciated that collaborations can be invoked with the communicators of the collaboration space by selecting the collaboration space even when the identities of communicators within the collaboration space are unknown by an initiator. That is, the initiator can communicate with members of a collaboration space without knowing or necessarily caring about the component members belonging to the collaboration space. For example, a meeting facilitator can convey meeting-specific digital content to communicators belonging to a collaboration space consisting of meeting attendees. Further, the meeting attendees can include one or more virtual meeting participants, who attend the meeting using a telepresence technology, such as a video teleconferencing.

New collaboration spaces can be formed by merging existing collaboration spaces. Accordingly, Collaboration Space A (all managers) can be combined with Collaboration Space B (communicators attending Meeting X) to form Collaboration Space C (managers attending Meeting X).

The present invention can be implemented in accordance with numerous aspects consistent with material presented herein. For example, one aspect of the present invention can include a method of communicating including a step of receiving a user selection of a collaboration space from a party. At the time of the selection a set of communicators occupying the collaboration space can be unknowable to the party, the set of communicators can be hidden from the party, and/or the set of communicators can be only known to the party because that set is presented to the communicator within a graphical user interface from which the user selection is made. The set of communicators occupying the collaboration space can be dynamically determined. A communication can be automatically exchanged between the party and at least one communicator of the determined set.

Another aspect of the present invention can include a communication method including a step of receiving a user selection of a collaboration space from a party. The collaboration space can be associated with a geographic region. Location beacons located within the geographic region can be dynamically detected. Each location beacon can be associated with a communicator. A set of communicators occupying the collaboration space can be automatically determined. The determined set of communicators can include those communicators associated with location beacons that are detected within the geographic region. A communication can be exchanged between the party and at least one communicator of the communication set responsive to a selection by the party. The party can select the collaboration space resulting in a user provided message being sent to each communicator in the collaboration space.

Still another aspect of the present invention can include a collaboration interface including a collaboration space and a collaboration space list. The collaboration space can be associated with at least one key attribute. The collaboration space list can include an identifier for each communicator occupying the collaboration space. The communicators occupying the collaboration space can be automatically and dynamically determined. The interface can include a graphical user interface section for composing a message. Further, the interface can include a user selectable mechanism for conveying a composed message. The mechanism can convey the message to user selected ones of the communicators occupying the collaboration space.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that includes a collaboration space in accordance with an embodiment of the inventive arrangements disclosed herein.

FIG. 2 is a schematic diagram of a system where a collaboration server can establish and manage collaboration spaces in accordance with an embodiment of the inventive arrangements disclosed herein.

FIG. 3 is an interface of a collaboration client in accordance with an embodiment of the inventive arrangements disclosed herein

FIG. 4 is an interface of a collaboration client showing a location map of a collaboration space in accordance with an embodiment of the inventive arrangements disclosed herein

FIG. 5 is an interface of a collaboration client showing historical collaboration spaces in accordance with an embodiment of the inventive arrangements disclosed herein

FIG. 6 is a flow chart of a method for conveying communications to communicators in a collaboration space in accordance with an embodiment of the inventive arrangements disclosed herein

FIG. 7 is a flow chart of a method, where a service agent can configure a system that communicates using collaboration spaces in accordance with an embodiment of the inventive arrangements disclosed herein.

### DETAILED DESCRIPTION OF THE INVENTION

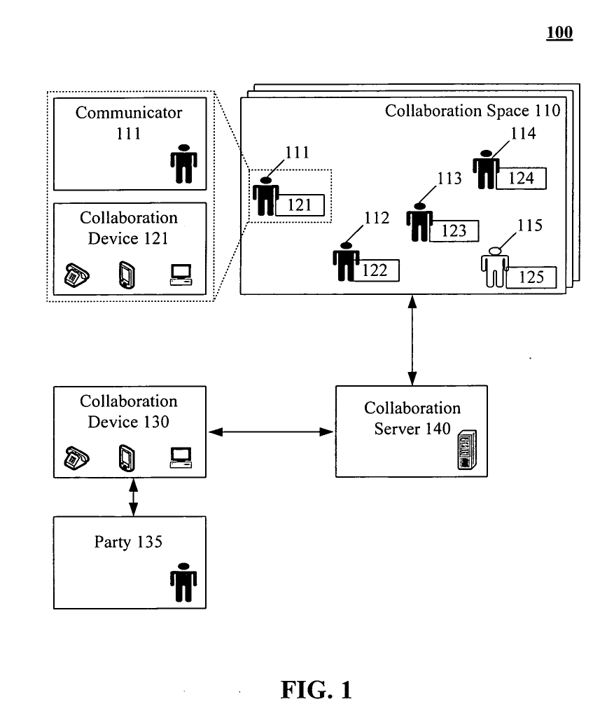

FIG. 1 is a schematic diagram of a system 100 that includes a collaboration space 110 in accordance with an embodiment of the inventive arrangements disclosed herein. In system 100, a party 135 utilizing a collaboration device 130 can select one or more collaboration spaces 110 using the collaboration server 140. The collaboration space 110 can include many different communicators 111-115. Each communicator 111-115 can be associated with a particular collaboration device 121-125. The party 135 can select a single one of the communicators 111 within the collaboration space 110 to receive a communication. Alternatively, the party 135 can send a communication to each communicator 111-115 in the collaboration space 110 by selecting the collaboration space 110 as a message recipient.

Collaboration devices 121-125 and 130 can include any computing device configured to exchange communications using at least one communication mode. Communication modes can include, but are not limited to, email, instant messages, chat, teleconference, video teleconferencing, e-meeting communications, co-browsing, and the like. Collaboration devices 121-125 and 130 can include a computer, a personal data assistant (PDA), a mobile phone, a telephone, a video teleconference unit, a fax machine, a media transceiver, and the like.

When sending communications to the collaboration space 110 the party 135 does not need to be aware of the identity of those communicators 111-115 that are part of the collaboration space 110. In one embodiment, identities of communicators 111-115 in the collaboration space can be intentionally hidden from the party 135 for privacy reasons so that one or more of the communicators 111-115 can remain anonymous to the party 135. In another embodiment, the members of the collaboration space 110 can dynamically change so that at any given time, communications conveyed by the party 135 to the collaboration space 110 will be sent to a different set of communicators 111-115.

The collaboration space 110 defines an electronic communication space using at least one attribute of an included set of communicators 111-115 other than an identity of the communicators. Multiple different communication modes can be used when communicating with communicators 111-115. Not all communicators 111-115 are necessary able to receive communications using all of the different communication modes of the collaboration space 110. The modes of communication available to individual communicators 111-115 can be based upon supported modes of collaboration devices 121-125 used by the communicators 111-115 as well as modes supported by collaboration device 130 used by party 135.

For example, communicator 114 can carry a smart phone 124 capable of receiving instant messages, but not capable of receiving email. Thus, collaborations with communicator 114 can be possible via instant messages but not email. Similarly, a device 121, such as a BLACKBERRY, used by communicator 111 can be capable of receiving email messages, but not capable of receiving instant messages.

The defined set of communicators 111-115 can be based upon an attribute that causes membership in the collaborator space 110 to dynamically change over time. This attribute upon which the set of communicators 111-115 is based can be referred to herein as a key attribute of the collaboration space 110. For example, the key attribute can specify a geographic region, such as a meeting room. The set of communicators 111-115 present in the meeting room can change over time, causing the members of the collaboration space 110 to dynamically change in a corresponding fashion. The collaboration space 110 can include those communicators 111-115 currently in the geographic region. User location detection technologies can be used to dynamically and automatically determine which communicators 111-115 are present in the associated meeting room.

It is possible to define the collaboration space 110 using attributes other than a geographic region. For example, the collaboration space 110 can include managers who have attended a mandatory seminar, where the seminar is offered at many different times and at many different locations. The managers belonging to the collaboration space 110 will dynamically change as new managers attend the mandatory training. Accordingly, assuming that all managers attending the mandatory training are to receive updated meeting handouts, party 135 can select the collaboration space 110 corresponding to trained managers and convey the updated handouts electronically as an email attachment.

In one contemplated arrangement, party 135 can specify that the updated handouts are to be conveyed to communicators 111-115 entering the collaboration space 110 within a specified period. This period can occur after the party 135 has initially conveyed the handouts to an initial set of communicators 111-115 defined for the collaboration space 110. That is, party 135 can specify that any manager attending the mandatory training within the next month is to be automatically conveyed the updated handouts. When a manager enters collaboration space 110 (by attending the meeting within the month) the updated handouts are automatically sent to the manager without additional party 135 actions being required.

System 100 can permit different collaboration spaces 110 to be merged to generate new collaboration spaces. That is, the collaboration server 140 can merge two or more different collaboration spaces 110 together based on specific rules and conditions, which can be user specified. For example, a collaboration space 110 defined to include communicators in a meeting room can be merged with a different collaboration space including managers attending a training session so that a new collaboration space can be created consisting of those managers who have attended the training session that are present in the meeting room. Merger conditions can include set operations, such as AND, OR, XOR, XAND, NOT, and the like.

Further, additional condition and/or attributes can be incorporated into a collaboration space merger operation. For example, a Collaboration Space Z can be formed from communicators included in a merger of Collaboration Spaces A, X, and Y where a specified Attribute N is compared to (greater than/equal to/less than) another specified Attribute M. Multiple different attributes can be specified for generating a new collaboration space.

For example, a Collaboration Space D can be constructed by merging a Collaboration Space E and a Collaboration Space F, where the merged space has Attribute H and/or Attribute I. So that if Attribute H specifies workers in a retail sector and Attribute I specifies workers over 50 years old, the merged Collaboration Space D can include those communicators in both Collaboration Space E and F who work in retail and are older than 50 years of age.

The collaboration space 110 can include one or more virtual communicators 115. A virtual communicator 115 can be a communicator that fails to satisfy exact conditions for the collaboration space 110, yet which satisfies one or more replacement conditions. For example, a condition for the collaboration space 110 can be present in a meeting room. Communicators 111-114 can include people physically present in the meeting room. Virtual communicator 115 can include an individual not physically present in the meeting room, who is virtually participating in the meeting by way of a telepresence technology.

A telepresence technology as used herein can be any electronic communication technology that permits an individual to participate in a meeting or coordinated group interactive event when that individual is not physically present in a geographic location at which the meeting or interactive event is held. For example, the virtual communicator 115 can virtually participate in the meeting using e-meeting software, using video teleconferencing equipment, using voice teleconferencing equipment, and the like.

In another example, a collaboration space 110 can be defined as a meeting involving all participants of a private chat forum. Each participant of the private chat forum can be considered a virtual participant 115. In still another example, a collaboration space 110 can be defined as a set of students attending a classroom lecture, where some of the students are physically present in the classroom and others are remotely located students that are participating in the lecture through a telepresence technology. Each student not physically present in the classroom can be considered a virtual communicator 115 in the classroom collaboration space.

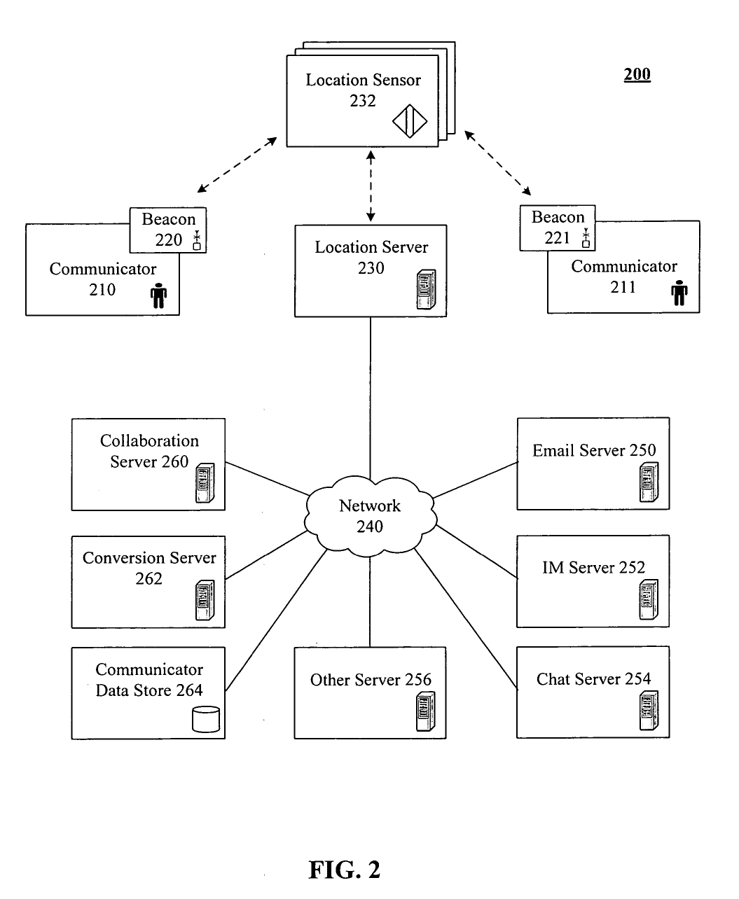

FIG. 2 is a schematic diagram of a system 200 where a collaboration server 260 can establish and manage collaboration spaces in accordance with an embodiment of the inventive arrangements disclosed herein. The collaboration server 260 can communicate using multiple communication modes. A number of individual communication servers, including an email server 250, an instant messaging server 252, a chat server 254, and other servers 256 can be used for mode specific communications. When communications occur between two or more parties that utilize different communication modes, a conversion server 262 can automatically convert messages from one format to the other.

Each communicator 210-211 occupying a collaboration space can have multiple associated attributes, which the collaboration server 260 can situationally utilize. For example, attributes of communicators 210-211 can be used when generating a new collaboration space using one or more existing collaboration spaces and one or more communicator attributes. A communicator data store 264 can be used to manage and store the communicator attributes and to relate these attributes to collaboration spaces.

In system 200, a location server 230 can dynamically and automatically determine communicator locations 210-211 to determine if these communicators 210-211 are located within geographic boundaries associated with one or more collaboration spaces. Each communicator 210-211 can be associated with a location beacon 220-221, which can be used by the location server 130 to determine a location for each communicator 210-211. Beacons 220-221 can include passive and active mechanisms. One or more location sensors 232 can be used in conjunction with the beacons 220-221.

For example, each of the beacon 220-221 can include an RFID tag embedded within a device commonly carried by communicator 210-211, such as a user's name tag, a parking pass, a keychain, a wallet card, a driver's license, and the like. RFID scanners (location sensor 232) can be strategically positioned so that locations of communicator 210-221 carried RFID tags can be automatically determined. Additionally, information embedded within the RFID tags can be used to specify data about a collaboration device or communicator 210-211. In most contained environments, such as an office, use of RFID tags and scanners are sufficient to accurately and cost efficiently monitor communicator 210-211 and/or collaboration device locations.

The use of other types of beacons 220-221 is contemplated herein. For example, a short distance transceiver can be used as a beacon 220-221. Short distance transceivers include BLUETOOTH transceivers, cellular transceivers, and wireless network transceivers (802.11 compliant protocols). Location scanners 232 can include BLUETOOTH servers, cellular towers, wireless access points, and the like. A distance of a beacon 220-221 to an access point can be determined based upon signal strength. A position of the beacon 220-221 can be triangulated based upon wireless signals received from multiple sensors 232. Short distance transceiver location determination can be particularly useful in relatively large environments having a relatively sparse user density.

When triangulation is used to determine beacon 220-221 location, location accuracy and precision can be enhanced by additional environmental input. For example, a location determination of a communicator 210-211 can be enhanced using video camera feedback of captured images taken from a collaboration space. Additionally, a mobile device including GPS components can be queried for precise location information.

Location server 230 can be a computing device that constantly tracks the locations of collaboration devices and communicators 210-211. The location server 230 can include a grid of a building or other environment, which includes environmental information, such as staircases, walls, doors, and windows. Using location server 230, communicators 210-211 can be mapped to their respective locations within the grid. This map can be displayed within a collaboration interface.

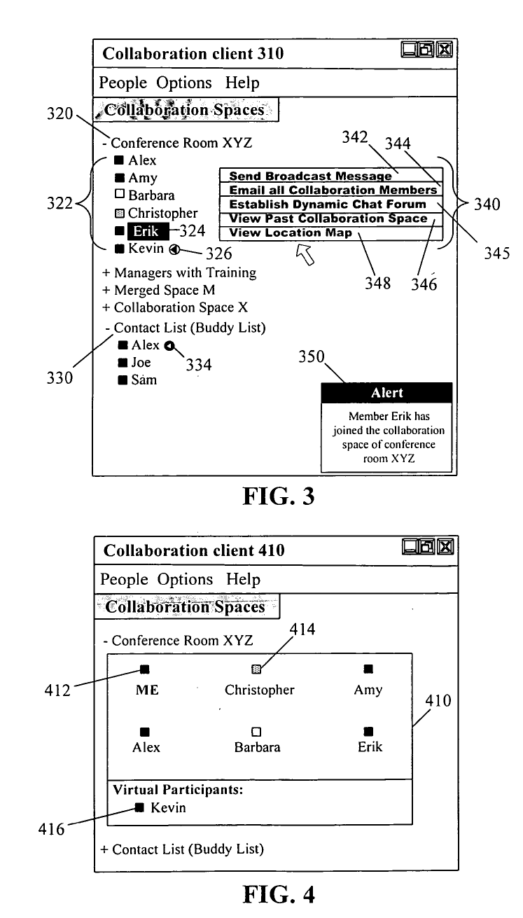

FIG. 3 is an interface of a collaboration client 310 in accordance with an embodiment of the inventive arrangements disclosed herein. The collaboration client can include one or more collaboration spaces, such as collaboration spaces for conference room 320, managers with training, for a merged Collaboration Space M, and for a Collaboration Space X. Client 310 can also include an instant message contact list 330, which is also commonly referred to as a “buddy list.”

The collaboration spaces and the contact list 330 can each include a list of communicators included within the associated collaboration space and/or contact list. For example, collaboration space 320 can include communicators 322. As illustrated, communicators 322 can include Alex, Amy, Barbara, Christopher, Erik, and Kevin. Communicators in contact list 330 can include Alex, Joe, and Sam. When a communicator is included in both contact list 330 and a collaboration space 320, a visual indicator 334, such as an icon, can be displayed next to the in the contact list. Thus, Alex's entry in the contact list 330 can include indicator 330.

A different visual indicator 326 can be presented next to a communicator's identifier, when that communicator is a virtual participant of a collaboration space. Since Kevin is a virtual participant of a meeting in conference room 320, visual indicator 326 is displayed next to Kevin.

An additional indicator can be included next to each communicator's identifier that indicates which communication modes are available for an associated communicator. For example, a black square can indicate that a communicator is available for instant messaging communication and email communication. A shaded square can indicate that a communicator is available for email communication but not instant messaging communication. An unfilled white square can indicate that an associated communicator is present in the collaboration space, but that no communication modes are available for client 310.

Accordingly in the collaboration space for conference room 320, Alex, Amy, Erik, and Kevin can receive instant messaging communications and email communications. Christopher can receive email communications only. Barbara is not able to receive communications from client 310. It should be noted that client 310 may only support a subset of the communication modes that are available for communicators 322 in the conference room 320. Thus, Barbara may be able to remotely communicate using a telephony communication mode, which is not supported by collaboration client 310. Other collaboration clients (not shown) can support the telephony communication mode.

The communicators in each collaboration space can be dynamically updated as membership in the collaboration space changes. For example, when Erik enters Conference Room XYZ, his entry can be automatically detected using location detection technologies. Collaboration clients 310 can receive an update from a collaboration server that indicates Erik is now present in the conference room. The client 310 can responsively add an identifier 324 for Erik. Additionally, an alert 350 can be presented to inform a user of client 310 that the communicators of conference room 320 have changed.

A popup window 340 can be presented in the collaboration client 310 that permits a user to select one or more communication options. For example, window 340 can include options to broadcast a message 342, to email all collaboration members 344, to establish a dynamic chat forum 345, to view a past collaboration space 346, and/or to view a location map 348.

When options 342-345 are selected and when a member of the selected collaboration space 320 is unable to receive messages using that communication mode, the message can be optionally automatically converted to a different communication mode. For example, when broadcast message option 342 is selected, all communicators 322 able to receive instant messages can receive the broadcast as an instant message. Other communicators 322, such as Christopher, can receive an email message that includes content automatically converted from a message that was broadcasted.

The option to establish a dynamic chat forum 345 can include a step of notifying each communicator 322 of the chat forum's location and of any pass codes necessary to participate in the chat forum.

FIG. 4 is an interface of a collaboration client 410 showing a location map 410 of a collaboration space in accordance with an embodiment of the inventive arrangements disclosed herein. The location map 410 can be presented responsive to a user selection of a view location map option 348. The location map 410 shows each participant of a collaboration space that is associated with a geographic region. A relative position of the participant within the geographic region is also shown in the map 410.

Icons or visual indicators can be included within the map 410 that indicates which communication modes are available for which communicators in the collaboration space. For example, the user (me 412) of the collaboration client 410, Amy, Alex, and Erik can each communicate using instant messages and email. Christopher 414 can communicate using email only, and Barbara cannot communicate using email or instant messages. A section of the map 410 can list virtual participants, such as Kevin 416, which are not physically present within the collaboration space.

In one embodiment, (not shown) the map 410 can include a video feed from the geographic region 410 that shows the images of actual participants in the geographic region. In another embodiment, (not shown) a two or three dimensional mapping of the participants in the geographic region can be shown. Mapping and location information presented within the map 410 can be updated dynamically in real time.

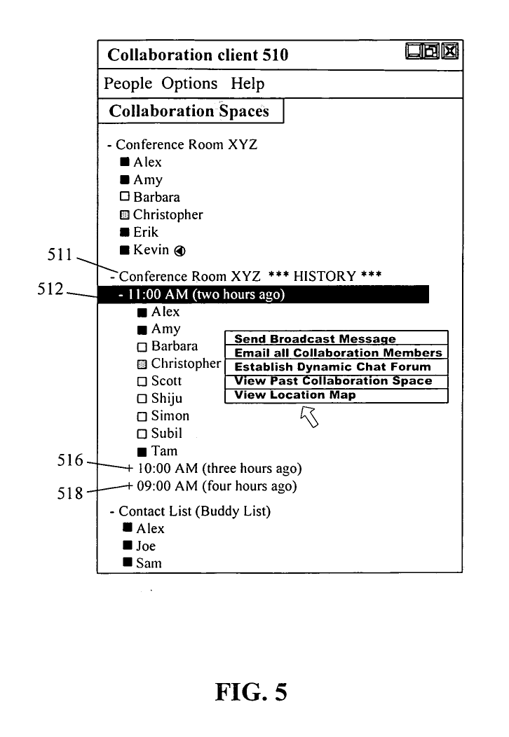

FIG. 5 is an interface of a collaboration client 510 showing historical collaboration spaces in accordance with an embodiment of the inventive arrangements disclosed herein. The client 510 can be presented responsive to a selection to view past collaboration spaces 346.

Client 510 can include a Conference Room XYZ history section 511. The section can show participants at user configured intervals or for a user specified period. As presented, section 511 shows the conference room at 11:00 A.M. within collaboration space 512, which was two hours ago assuming that a present time is 1:00 P.M. Section 511 can also include collaboration spaces 516 and 518 for the conference room at 10:00 A.M. and at 9:00 A.M.

Collaboration space 512 includes those communicators that were present in the conference room at 11:00 A.M. These communicators can include Alex, Amy, Barbara, Christopher, Scott, Shiju, Simon, Subil, and Tam.

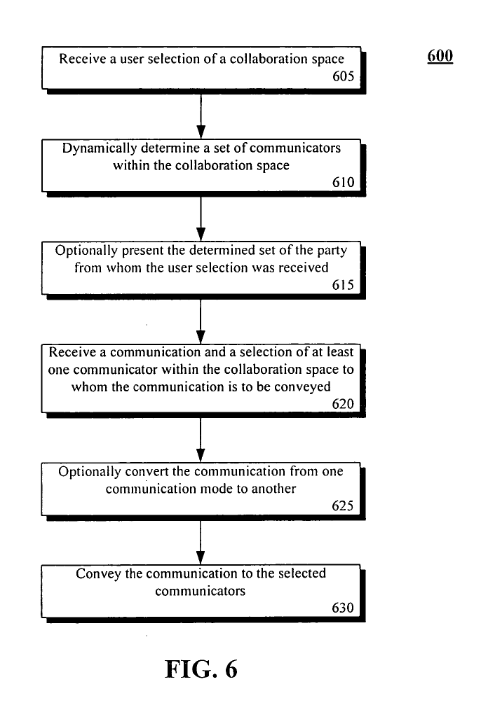

FIG. 6 is a flow chart of a method 600 for conveying communications to communicators in a collaboration space in accordance with an embodiment of the inventive arrangements disclosed herein. Method 600 can be performed in the context of a system 100 and/or 200.

Method 600 can begin in step 605, where a user selection of a collaboration space can be received. In step 610, a set of communicators within the collaboration space can be dynamically determined. In step 615, the determined set can be optionally presented to a party from whom the selection was received. For example, the determined set can be listed within a collaboration interface used by the party. In step 620, a communication generated by the party can be provided to a collaboration server. The party can also specify at least one communicator belonging to the collaboration space that is to receive the communication. The selection for the communicators can be performed by explicitly selecting user identities from within a collaboration interface. The selection can also be performed by selecting the collaboration space itself. Selecting the collaboration space can cause each communicator in a collaboration space capable of receiving the communication to receive it.

In optional step 625, the communication can be converted from one communication mode to another. For example, the original communication can be an email message, which can be converted to an instant message format and then sent to a communicator having instant messaging capabilities but not having email capabilities. The conversion can be performed bidirectionally. In step 630, the party provided communication can be conveyed to the selected communicators.

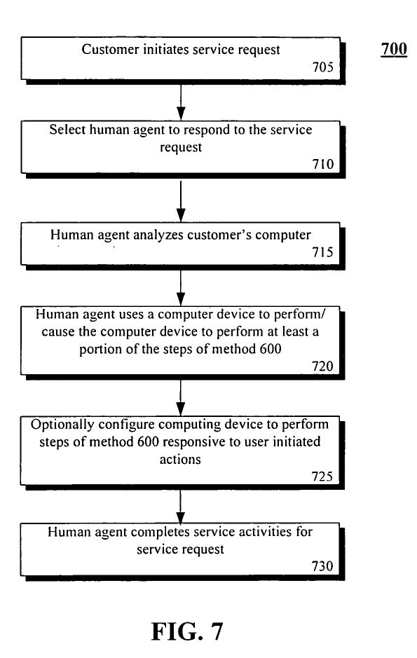

FIG. 7 is a flow chart of a method 700, where a service agent can configure a system that communicates using collaboration spaces in accordance with an embodiment of the inventive arrangements disclosed herein. Method 700 can be preformed in the context of system 100 and/or 200.

Method 700 can begin in step 705, when a customer initiates a service request. The service request can be a request for a service agent to establish hardware and/or software to enable a business to utilize collaboration spaces. The service request can also be a request to troubleshoot a problem or to upgrade an existing system having collaboration spaces. Additionally, the request can be for an enhancement of location determination system that determines which communicators are included within a collaboration space associated with a geographic region.

In step 710, a human agent can be selected to respond to the service request. In step 715, the human agent can analyze a customer's current system and can develop a solution. The solution can include the acquisition and deployment of additional hardware, such as a collaboration server, location beacons, and location sensors.

In step 720, the human agent can use one or more computing devices to perform or to cause the computer device to perform the steps of method 600. In optional step 725, the human agent can configure the customer's computer in a manner that the customer or clients of the customer can perform one or more steps of method 600 in the future. For example, the service agent can load and configure a collaboration server so that collaboration clients can exchange communications based upon defined collaboration spaces. In step 730, the human agent can complete the service activities.

It should be noted that while the human agent may physically travel to a location local to adjust the customer's computer or application server, physical travel may be unnecessary. For example, the human agent can use a remote agent to remotely manipulate the customer's computer system and/or an application server.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of communicating comprising:
receiving a user selection of a collaboration space from a party, wherein at least one selection condition is true at a time of the selection, said selection condition including a condition selected from a group consisting of a condition where a set of communicators occupying the collaboration space is unknowable to the party, a condition where the set of communicators is hidden from the party, a condition where the set of communicators is only known the party because that set is presented to the communicator within a graphical user interface from which the user selection is made;
dynamically determining the set of communicators occupying the collaboration space; and
automatically exchanging a communication between the party and at least one communicator of the determined set.

2. The method of claim 1, wherein the collaboration space is associated with a geographical region, said determining step further comprising:
automatically determining a set of communicators within the geographic region.

3. The method of claim 2, said method further comprising:
receiving a time from the user, wherein the determining step further comprises querying a historical data store for the set of communicators within the geographic region at the received time.

4. The method of claim 2, further comprising:
associating a plurality of location beacons with communicators; and
automatically ascertaining location beacons within the geographic region, wherein the determining step further comprises determining the set of communicators occurring the collaboration space based upon the ascertaining step.

5. The method of claim 1, wherein the at least one communicator comprises each communicator of the communication set.

6. The method of claim 1, wherein a plurality of communication modes exist for communicating with the communicators occupying the collaboration space, said method further comprising:
identifying a communication mode for the party; and
determining a communication set consisting of those communicators able to communicate via the identified communication mode, wherein the exchanging step exchanges communications between the party and each of the communicators of the communication set using the identified communication mode.

7. The method of claim 1, wherein the steps of claim 1 are performed by at least one of a service agent and a computing device manipulated by the service agent, the steps being performed in response to a service request.

8. A communication method comprising:
receiving a user selection of a collaboration space from a party, wherein the collaboration space is associated with a geographic region;
dynamically detecting a plurality of location beacons within the geographic region, wherein each location-beacon is associated with a communicator;
automatically determining a set of communicators occupying the collaboration space, wherein each communicator in the set is associated with a location beacon detected within the geographic region; and
exchanging a communication between the party and at least one communicator of the communication set responsive to a selection by the party to communicate with the at least one communicator.

9. The communication method of claim 8, wherein the communication comprises at least one email message and at least one instant messaging communication.

10. The method of claim 8, further comprising:
providing a collaboration interface, wherein the collaboration interface includes a party selectable option for conveying an email message to each communicator in the set of communicators that has email communication capabilities.

11. The method of claim 8 further comprising:
providing a collaboration interface, wherein the collaboration interface includes a party selectable option for broadcasting an instant message to each communicator in the set of communicators that has instant messaging communication capabilities.

12. The method of claim 8 further comprising:
providing a collaboration interface comprising at least one collaboration space list;
presenting within the collaboration space list an identifier for each communicator of the set, wherein the identifiers in the collaboration space list are dynamically updated as communicators within the geographic region change.

13. The method of claim 12, wherein the collaboration interface includes an instant message contact list.

14. The method of claim 8, wherein the steps of claim 8 are performed by at least one of a service agent and a computing device manipulated by the service agent, the steps being performed in response to a service request.

15. A collaboration interface comprising:
at least one collaboration space associated with at least one key attribute;
a collaboration space list comprising an identifier for each communicator occupying the collaboration space, wherein the communicators occupying the collaboration space are automatically and dynamically determined;
a graphical user interface section for composing a message; and
a user selectable mechanism for conveying a composed message to a user selected ones of the communicators occupying the collaboration space.

16. The interface of claim 15, wherein the at least one key attribute includes a geographic region, wherein each communicator occupying the collaboration space is determined by detecting a presence of a plurality of location beacons within the geographic region, wherein each location beacon is associated with a communicator.

17. The interface of claim 16, wherein at least one of the communicators occupying the collaboration space is a virtual communicator not physically located in the geographic region, and wherein the virtual communicator has a telepresence in the geographic region, said interface further comprising:
a virtual communicator identifier presented proximate to the identifier for the virtual communicator in the interface.

18. The interface of claim 15, further comprising:
a historic collaboration space list associated with a specified time other than a current time, wherein the historic collaboration space list comprises an identifier for each communicator occupying the collaboration space at the specified time.

19. The interface of claim 15, wherein the user selectable mechanism includes a plurality of options to convey the composed message using different user selectable communication modes, wherein the options comprise at least one option selected from a group consisting of an option to email the composed message to each communicator occupying the collaboration space and an option to broadcast the composed message to each communicator occupying the collaboration space using an instant messaging technology to perform the broadcast.

20. The interface of claim 15, further comprising:
an instant message contact list within which identifiers for a plurality of communicators is presented, wherein a descriptor is presented next to each identifier when an associated communicator is part of both the contact list and the collaboration space.
